(19) United States
(12) Patent Application Publication
(10) Pub. No.: US 2024/0364393 A1
(43) Pub. Date: Oct. 31, 2024

(54) DEMODULATION REFERENCE SIGNAL ASSISTED CHANNEL STATE INFORMATION FEEDBACK SCHEME

(71) Applicant: Nokia Technologies Oy, Espoo (FI)

(72) Inventors: Rana AHMED, Stuttgart (DE); Filippo TOSATO, Massy (FR)

(21) Appl. No.: 18/291,096

(22) PCT Filed: Sep. 9, 2022
(86) PCT No.: PCT/IB2022/058524

§ 371 Date: Jan. 22, 2024

Related U.S. Application Data
(60) Provisional application No. 63/243,568, filed on Sep. 13, 2021.

(51) Int. Cl. H04B 7/0456; H04B 7/06

(52) U.S. Cl. CPC H04B 7/0456; H04B 7/0626; H04B 7/0632

(57) ABSTRACT

Systems, methods, apparatuses, and computer program products for providing CSI updates based on DMRS transmissions. One method may include a UE transmitting CSI-RS based CSI feedback generated according to a configured codebook, generating DMRS based precoding matrix indicator feedback according to the configured codebook, and transmitting the DMRS based precoding matrix indicator feedback to a network entity.

### TECHNICAL FIELD

Some example embodiments may generally relate to mobile or wireless telecommunication systems, such as Long Term Evolution (LTE), fifth generation (5G) radio access technology (RAT), new radio (NR) access technology, and/or other communications systems. For example, certain example embodiments may relate to systems and/or methods for providing channel state information (CSI) updates based on demodulation reference signal (DMRS) transmissions.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, by a user equipment, channel state information reference signal based channel state information feedback generated according to a configured codebook to a network entity. The method may further include generating, by the user equipment, demodulation reference signal based precoding matrix indicator feedback according to the configured codebook to a network entity. The method may further include transmitting, by the user equipment, the demodulation reference signal based precoding matrix indicator feedback to the network entity.

In accordance with certain example embodiments, an apparatus may include means for transmitting channel state information reference signal based channel state information feedback generated according to a configured codebook to a network entity. The apparatus may further include means for generating demodulation reference signal based precoding matrix indicator feedback according to the configured codebook to a network entity. The apparatus may further include means for transmitting the demodulation reference signal based precoding matrix indicator feedback to the network entity.

In accordance with various example embodiments, an apparatus may include at least one processor and at least one memory including computer program code. The at least one memory and the computer program code may be configured to, with the at least one processor, cause the apparatus to at least transmit channel state information reference signal based channel state information feedback generated according to a configured codebook to a network entity. The at least one memory and the computer program code may be further configured to, with the at least one processor, cause the apparatus to at least generate demodulation reference signal based precoding matrix indicator feedback according to the configured codebook to a network entity. The at least one memory and the computer program code may be further configured to, with the at least one processor, cause the apparatus to at least transmit the demodulation reference signal based precoding matrix indicator feedback to the network entity.

In accordance with some example embodiments, a non-transitory computer readable medium may be encoded with instructions that may, when executed in hardware, perform a method. The method may include transmitting channel state information reference signal based channel state information feedback generated according to a configured codebook to a network entity. The method may further include generating demodulation reference signal based precoding matrix indicator feedback according to the configured codebook to a network entity. The method may further include transmitting the demodulation reference signal based precoding matrix indicator feedback to the network entity.

In accordance with certain example embodiments, a computer program product may perform a method. The method may include transmitting channel state information reference signal based channel state information feedback generated according to a configured codebook to a network entity. The method may further include generating demodulation reference signal based precoding matrix indicator feedback according to the configured codebook to a network entity. The method may further include transmitting the demodulation reference signal based precoding matrix indicator feedback to the network entity.

In accordance with various example embodiments, an apparatus may include circuitry configured to transmit channel state information reference signal based channel state information feedback generated according to a configured codebook to a network entity. The circuitry may further be configured to generate demodulation reference signal based precoding matrix indicator feedback according to the configured codebook to a network entity. The circuitry may further be configured to transmit the demodulation reference signal based precoding matrix indicator feedback to the network entity.

In accordance with some example embodiments, a method may include receiving, by a network entity, channel state information reference signal based channel state information feedback generated according to a configured codebook from a user equipment. The method may further include generating, by the network entity, based upon the channel state information reference signal based channel state information feedback, a downlink precoder and computing at least one demodulation reference signal. The method may further include updating, by the network entity, the downlink precoder and at least one modulation and coding scheme.

In accordance with certain example embodiments, an apparatus may include means for receiving channel state information reference signal based channel state information feedback generated according to a configured codebook from a user equipment. The apparatus may further include means for generating, based upon the channel state information reference signal based channel state information feedback, a downlink precoder and computing at least one demodulation reference signal. The apparatus may further include means for updating the downlink precoder and at least one modulation and coding scheme.

In accordance with various example embodiments, an apparatus may include at least one processor and at least one memory including computer program code. The at least one memory and the computer program code may be configured to, with the at least one processor, cause the apparatus to at least receive channel state information reference signal based channel state information feedback generated according to a configured codebook from a user equipment. The at least one memory and the computer program code may be further configured to, with the at least one processor, cause the apparatus to at least generate, based upon the channel state information reference signal based channel state information feedback, a downlink precoder and computing at least one demodulation reference signal. The at least one memory and the computer program code may be further configured to, with the at least one processor, cause the apparatus to at least update the downlink precoder and at least one modulation and coding scheme.

In accordance with some example embodiments, a non-transitory computer readable medium may be encoded with instructions that may, when executed in hardware, perform a method. The method may include receive channel state information reference signal based channel state information feedback generated according to a configured codebook from a user equipment. The method may further include generate, based upon the channel state information reference signal based channel state information feedback, a downlink precoder and computing at least one demodulation reference signal. The method may further include update the downlink precoder and at least one modulation and coding scheme.

In accordance with certain example embodiments, a computer program product may perform a method. The method may include receive channel state information reference signal based channel state information feedback generated according to a configured codebook from a user equipment. The method may further include generate, based upon the channel state information reference signal based channel state information feedback, a downlink precoder and computing at least one demodulation reference signal. The method may further include update the downlink precoder and at least one modulation and coding scheme.

In accordance with various example embodiments, an apparatus may include circuitry configured to receive channel state information reference signal based channel state information feedback generated according to a configured codebook from a user equipment. The circuitry may further be configured to generate, based upon the channel state information reference signal based channel state information feedback, a downlink precoder and computing at least one demodulation reference signal. The circuitry may further be configured to update the downlink precoder and at least one modulation and coding scheme.

### BRIEF DESCRIPTION OF THE DRAWINGS

For proper understanding of example embodiments, reference should be made to the accompanying drawings, wherein:

FIG. 1 illustrates an example of a DMRS assisted CSI feedback scheme for 5G advanced according to various embodiments.

FIG. 2 illustrates an example of a signaling diagram according to certain example embodiments.

FIG. 3 illustrates an example of a flow diagram of a method according to some example embodiments.

FIG. 4 illustrates an example of a flow diagram of another method according to various example embodiments.

FIG. 5 illustrates an example of chordal distance metrics for layer 1 and 2 for a low speed user according to some embodiments.

FIG. 6 illustrates an example of chordal distance metrics for layer 1 and 2 for a high speed user according to certain embodiments.

FIG. 7 illustrates an example of various network devices according to some example embodiments.

FIG. 8 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing CSI updates based on DMRS transmissions is not intended to limit the scope of certain example embodiments, but is instead representative of selected example embodiments.

In 3GPP 5G frequency division duplex (FDD) systems, a base station may use downlink reference signal (e.g., channel state information reference signal (CSI-RS), synchronization signal block (SSB)) transmissions and/or CSI feedback from user equipment in uplink (UL) in order to obtain CSI that the base station (e.g., gNB) may require for downlink (DL) precoding, scheduling, etc. One aspect for consideration is high mobility support; advantages provided by more advanced codebooks (e.g., eType II, further enhanced port selection (FePS)) tend to disappear as user speed increases, including at moderate speeds. One potential solution for channel aging includes CSI prediction.

In 5G NR, the gNB may transmit DL CSI-RS, allowing the UE to measure DL spatial channels. Based on this measurement, the UE may build the DL CSI, such as recommended precoder matrix indicator (PMI) and/or channel quality indication (CQI), and provide this information back to the gNB. The gNB may use PMI received from one or more UEs to build a precoder for data and demodulation reference signals (DM-RS), which may have varying codebook structures. For example, in an eType II codebook, the precoder may be built according to W=W₁\tilde{W}₂W_{f}^{H} (2). As an example, data precoder W may contain complex weights that should be assigned across all antenna ports, mapping them to a number of data streams v. The number of data streams v may be determined jointly by the UE and the gNB, where the UE transmits to the gNB a recommended number of layers in CSI feedback, which the gNB may be able to decrease.

For example, the grid-of-beam (GoB) matrix W₁ may have size 2N₁N₂×2L, and may be built out of L orthogonal vectors/beams per polarization r from a set of oversampled O₁O₂N₁N₂ DFT beams. In this case, N₁ and N₂ may be the number of antenna ports in horizontal and vertical domains, and O₁ and O₂ may be the oversampling factors in both dimensions. This collection of vectors may be used to approximate the eigenvectors of the channel covariance matrix by means of suitable weighted linear combinations. This operation may achieve a compression in the spatial domain (SD); thus, the resulting 2L beams may be referred to as SD components. \tilde{W}₂ may be a 2L×M matrix of linear combining coefficients, W_{f} may be an N₃×M FD compression matrix (analogous to W₁ in frequency domain), where M may be the number of frequency domain (FD) components. In 3GPP Rel-16 type II CSI, the UE may transmit to the gNB any of GoB matrix W₁, FD basis subset W_{f}, and linear combination coefficients (LCC) \tilde{W}₂. DM-RS for physical downlink shared channel (PDSCH) and physical uplink shared channel (PUSCH) are reference signals (i.e., data training pilots), which may be transmitted on the same antenna port(s) as those used for the resource elements carrying the data, and are intended to be used for channel estimation of the corresponding antenna ports. PDSCH DM-RS may be used for PDSCH data demodulation; thus, one difference between the channel measured by CSI-RS and the channel measured by PDSCH DM-RS is that the effective channel measured by DM-RS may include the data precoder which the gNB has built using the CSI feedback as described above in equation (2).

Enhancements to 3GPP Rel-17 MIMO CSI have assumed a very frequent CSI feedback (e.g., 5 ms), which, in some cases, is the fastest feasible feedback periodicity since CSI-RS may not be transmitted at a higher rate. Configuring UEs in a cell with 5 ms feedback periodicity may be difficult since the high CSI-RS overhead may not be feasible with UE specific CSI-RS, and many UEs may be simultaneously active in one cell. While the feedback periodicity may be reduced by transmitting CSI-RS more often, the advantages of high resolution codebooks may tend to diminish, including for low speed users.

Certain example embodiments described herein may have various benefits and/or advantages to overcome at least the disadvantages described above. For example, certain example embodiments may transmit DMRS in multiple or all subframes more frequently than CSI-RS. Unlike CSI-RS, which has a minimum periodicity less than 5 ms, DMRS may be transmitted in each subframe, thereby not requiring DL overhead. In certain embodiments, the UL overhead from the CSI feedback based on DMRS may be smaller than the UL overhead based on CSI-RS transmissions, since UL overhead may scale based on the number of layers (maximum 8 layers with NR Type I feedback and 4 layers with NR eType II CSI feedback) and not with the number of antenna ports (which can reach up to 32 antenna ports in NR). Hence, certain embodiments may allow more than 32 antenna ports. Thus, certain example embodiments discussed below are directed at least to improvements in computer-related technology.

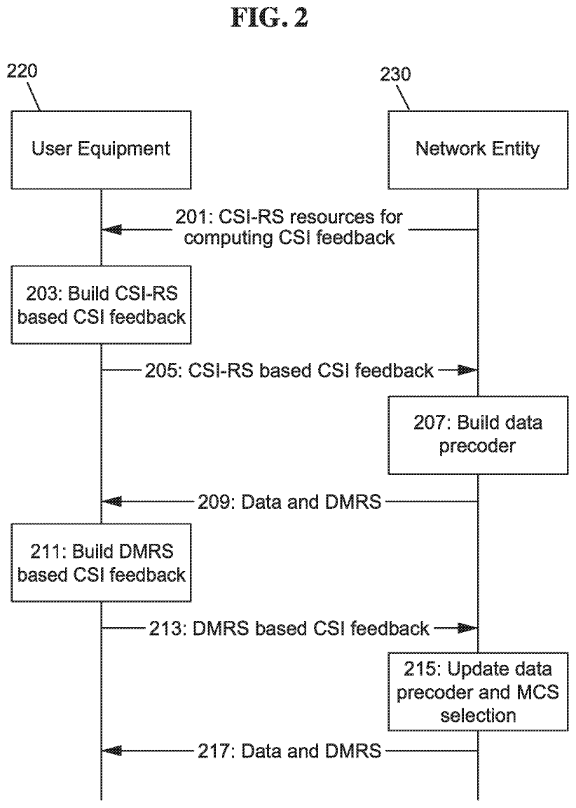

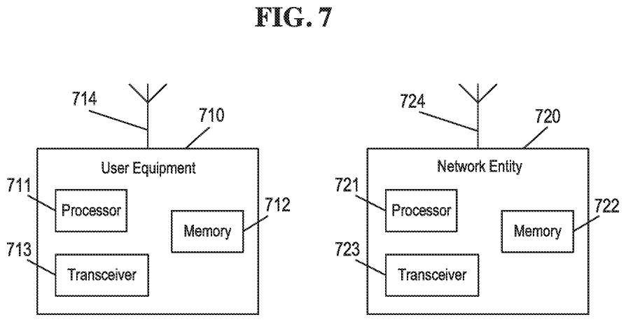

FIG. 2 illustrates an example of a signaling diagram depicting how to provide CSI updates based on DMRS transmissions, according to an example embodiment. UE 220 and NE 230 may be similar to UE 710 and NE 720, as illustrated in FIG. 7, according to certain example embodiments.

At 201, NE 230 may transmit to UE 220 at least one data layer and corresponding DMRS, and at 203, NE 230 may transmit CSI-RS reference signals in DL to UE 220. In response, UE 220 may use the received CSI-RS reference signals to calculate the DL CSI at time T=0 H_{N}_{ᵣ}_{×N}_{ₜ}_{×N}_{_{f}}^{CSI-RS}(0), where Nᵣ may be the number of receive antennas, Nₜ may be the number of antenna ports, and N_{f} may be the number of frequency points (e.g., number of subbands).

At 205, UE 220 may calculate CSI feedback using a configured codebook structure, and at 207, may send CSI-RS based CSI feedback to NE 230. In some embodiments, the PMI of the configured codebook structure may include any of W₁ (spatial GoB matrix), W_{f} (frequency domain basis subset matrix), W_{D} (Doppler domain basis subset matrix, and/or W₂ (matrix of quantized linear combination coefficients).

At 209, based upon the CSI-RS based CSI feedback, NE 230 may compute a DL precoder for data. Furthermore, NE 230 may compute DMRS W_{N}_{ₜ}_{×v×N}_{₃}^{data}(T=0), which may include weights needed to be assigned on Nₜ antenna ports to get v layers over N₃ subbands. In some embodiments, NE 230 may apply the computed DL precoder on DMRS in a DL domain, and in response, UE 220 may measure a DL DMRS channel, which may be according to H_{N}_{ᵣ}_{×v×N}_{_{f}}^{dmrs}. At 211, NE 230 may transmit data and DMRS to UE 220.

At 213, based upon H_{N}_{ᵣ}_{×v×N}_{_{f}}^{dmrs}, UE 220 may build DMRS based CSI feedback and/or compute an optimum “incremental” precoder over an existing CSI-RS based precoder W_{N}_{ₜ}_{×v×N}_{₃} and/or updates for other CSI quantities, such as RI and CQI. The new “incremental” precoder may provide a rotation to a vector space of W_{N}_{ₜ}_{×v×N}_{₃} in order to reduce channel aging effect (i.e., rotate the vector space according to new information captured by the DMRS channel at time T=1). At 215, UE 220 may feed back the “incremental” precoder V_{v×v×N}_{₃}, which may also be compressed in frequency and Doppler domain.

In some embodiments,_{[FT1]} UE 220 may apply a frequency domain compression, wherein by exploiting the correlation in the frequency domain, the UL overhead may be reduced, for example, by using a discrete Fourier transform (DFT) based codebook V_{v×v×N}_{₃}=X_{v×v×M}_{_{D}}¹V_{f}_{_{M}}^{D}_{xN}_{₃}. In this case, instead of sending vN₃ coefficients per layer, at most vM^{D} coefficients may be fed back per layer (in V_{v×v×M}_{^{D}}¹), where M^{D}<N₃. If a DFT compression is used, the columns in V_{f}_{_{M}}^{D}_{xN}_{₃} may be derived from a DFT codebook, and UE 220 only needs to send back the column indices and potentially an oversampling factor. In certain example embodiments, UE 220 may apply a layer domain compression on top of frequency domain compression, wherein orthogonality between reported layers may also be exploited for overhead reduction (e.g., using Givens transformations). In various example embodiments, UE 220 may apply a Doppler domain compression. As noted above, DMRS based feedback may describe an incremental feedback on top of a full CSI-RS based precoder. In certain configurations, there may be some correlation among successive feedback instants in the time domain, which may be used to compress successive feedback instants, and feed that information to NE 230, which may be used by NE 230 perform predictions.

At 217, NE 230 may update the data precoder at one subband position n₃ (or at one FD component index) as W_{N}_{ₜ}_{×v}^{data}(T=1, n₃)=W_{N}_{ₜ}_{×v}^{data}(T=0, n₃)V_{v×v}(T=1, n₃).

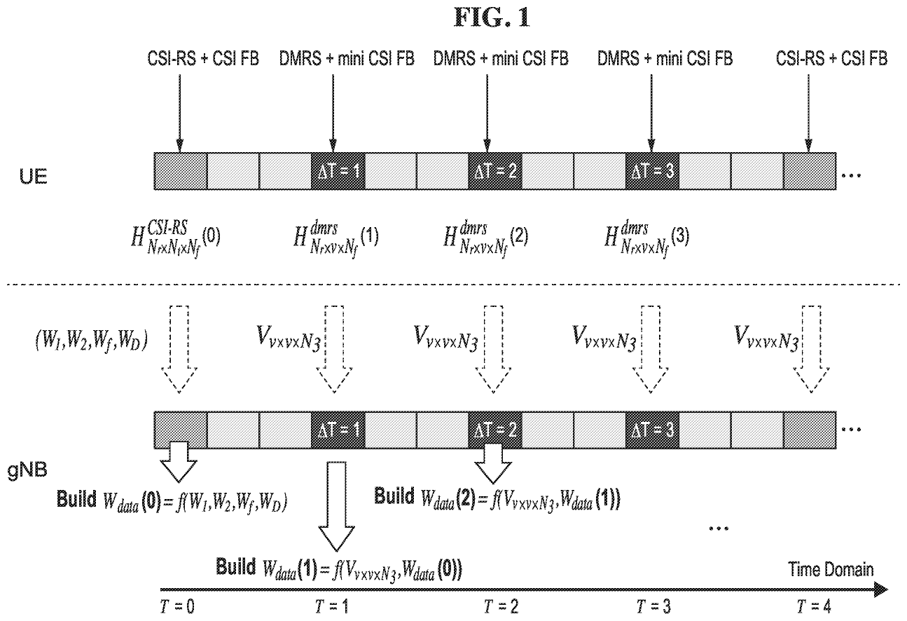

In certain embodiments, the CQI and RI may be updated substantially simultaneously. In some embodiments, the at least one RRC parameter may include DMRS feedback periodicity (e.g., ΔT in FIG. 1), DMRS based PMI codebook format, and CSI quantities that need to be updated (e.g., PMI, CQI, RI). In some embodiments, UE 220 may transmit the new “incremental” precoder at a respective time instant, and in response, NE 230 may update the DL precoder. Additionally, UE 220 may transmit a CSI-RS based full CSI feedback (i.e., not incremental) to NE 230. In some embodiments, the incremental feedback V_{v×v×N}_{₃} may have the same frequency resolution as the data precoder for simplicity; the incremental feedback may be of higher frequency resolution (e.g., V_{v×v×2N}_{₃}) or at a lower frequency resolution (e.g., V_{v×v×0.5N}_{₃}).

In various embodiments, based on the new DMRS based PMI feedback, NE 230 may configure UE 220 to update the CQI and RI. In certain embodiments, the CQI and RI may be updated substantially simultaneously. The RI and the CQI may be smaller than the variants which have been transmitted at T=0: the CSI-RS based CSI feedback. Thus, UE 220 may encode each of the RI and the CQI differentially with respect to reference values of RI and CQI, respectively, transmitted at T=0: the CSI-RS based CSI feedback, where the quantization levels represented lead to a final smaller value. For example, for the differential CQI,

$${CQI}_{diff} = \frac{CQI ( Δ T )}{CQI ( T = 0 )} ,$$

quantization levels may all be used in a range <1. The differential RI may be transmitted where the levels that need to be encoded are {1, . . . , RI(T=0)}.

In various embodiments|_{[FT2]}, in a case of a reduced RI (for example, UE 220 updates rank to v′<v), the CSI-RS precoder update may occur at NE 230 in two ways. First, UE 220 may modify the DMRS based updated to drop the last discarded v-v′ layer(s) or NE 230 may drop the last discarded v-v′ layer(s) of the precoder; wherein equation 3 would be revised to W_{N}_{ₜ}_{×v′}^{data}(T=1, n₃)=W_{N}_{ₜ}_{×v′}^{data}(T=0, n₃)V_{v′×v′}(T=1, n₃) (4). Second, UE 220 may modify the DMRS based updated to drop the last discarded v-v′ column(s) or NE 230 may drop the last discarded v-v′ column(s) of the precoder, wherein equation 3 would be updated to W_{N}_{ₜ}_{×v′}^{data}(T=1, n₃)=W_{N}_{ₜ}_{×v}^{data}(T=0, n₃)V_{v×v′}(T=1, n₃) (5).

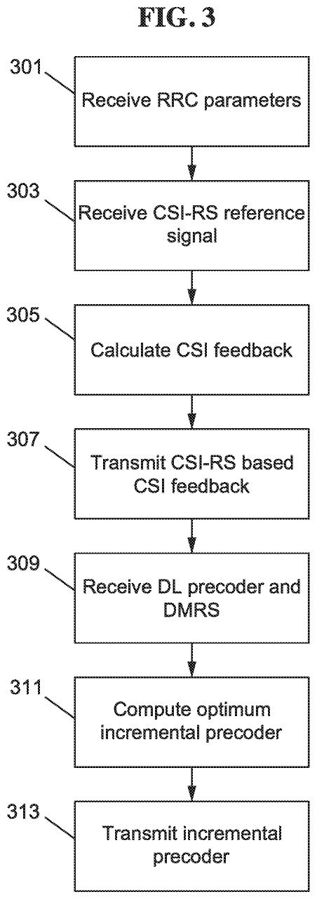

FIG. 3 illustrates an example of a flow diagram of a method that may be performed by a UE, such as UE 710 illustrated in FIG. 7, according to various example embodiments.

At 301, the method may include receiving at least one data layer and corresponding DMRS from the NE. The method may further include receiving an updated data precoder at one subband position n₃ (or at one FD component index) according to W_{N}_{ₜ}_{×v}^{data}(T=1, n₃)=W_{N}_{ₜ}_{×v}^{data}(T=0, n₃)V_{v×v}(T=1, n₃).

At 303, the method may include receiving reference signals CSI-RS in DL from a NE, such as NE 720 in FIG. 7. In response, the UE may use the received reference signals CSI-RS to calculate the DL CSI at time T=0 H_{N}_{ᵣ}_{×N}_{ₜ}_{×N}_{_{f}}^{CSI-RS}(0), where Nᵣ may be the number of receive antennas, Nₜ may be the number of antenna ports, and N_{f} may be the number of frequency points (e.g., number of subbands).

At 305, the method may include calculating CSI feedback, and at 307, sending CSI-RS based CSI feedback to the NE. In some embodiments, the PMI of the configured codebook structure may include any of W₁ (spatial GoB matrix), W_{f} (frequency domain basis subset matrix), W_{D} (Doppler domain basis subset matrix, and W₂ (matrix of quantized linear combination coefficients).

At 309, the method may include receiving data and DMRS from the NE. The DL precoder may be based upon the CSI-RS based CSI feedback, and the DMRS may be computed according to W_{N}_{ₜ}_{×v×N}_{₃}^{data}(T=0), which may include weights needed to be assigned on Nₜ antenna ports to get v layers over N₃ subbands. In some embodiments, the computed DL precoder may be applied on DMRS in a DL domain.

At 311, based upon H_{N}_{ᵣ}_{×v×N}_{_{f}}^{dmrs}, the method may include computing an optimum “incremental” precoder over an existing CSI-RS based precoder W_{N}_{ₜ}_{×v×N}_{₃} and/or updates for other CSI quantities, such as RI and CQI. The new “incremental” precoder may provide a rotation to a vector space of W_{N}_{ₜ}_{×v×N}_{₃} in order to reduce channel aging effect (i.e., rotate the vector space according to new information captured by the DMRS channel at time T=1). At 313, the method may include feeding back the “incremental” precoder V_{v×v×N}_{₃}, which may also be compressed in frequency and Doppler domain.

In some embodiments, UE 220 may apply a frequency domain compression, wherein by exploiting the correlation in the frequency domain, the UL overhead may be reduced, for example, by using a DFT based codebook V_{v×v×N}_{₃}=V_{v×v×M}_{^{D}}¹. In this case, instead of sending vN₃ coefficients per layer, at most vM^{D} coefficients may be fed back per layer (in V_{v×v×M}_{^{D}}¹), where M^{D}<N₃. If a DFT compression is used, the columns in V_{f}_{_{M}}^{D}_{xN}_{₃} may be derived from a DFT codebook, and UE 220 only needs to send back the column indices and potentially an oversampling factor. In certain example embodiments, UE 220 may apply a layer domain compression on top of frequency domain compression, wherein orthogonality between reported layers may also be exploited for overhead reduction (e.g., using Givens transformations). In various example embodiments, UE 220 may apply a Doppler domain compression. As noted above, DMRS based feedback may describe an incremental feedback on top of a full CSI-RS based precoder. In certain configurations, there may be some correlation among successive feedback instants in the time domain, which may be used to compress successive feedback instants, and feed that information to NE 230, which may be used by NE 230 perform predictions.

In certain embodiments, the CQI and RI may be updated substantially simultaneously. In some embodiments, the at least one RRC parameter may include DMRS feedback periodicity (e.g., ΔT in FIG. 1), DMRS based PMI codebook format, and CSI quantities that need to be updated (e.g., PMI, CQI, RI). In some embodiments, the method may include transmitting the new “incremental” precoder at a respective time instant, and in response, the NE may update the DL precoder. Additionally, the method may include transmitting a CSI-RS based full CSI feedback (i.e., not incremental) to the NE. In some embodiments, the incremental feedback V_{v×v×N}_{₃} may have the same frequency resolution as the data precoder for simplicity; the incremental feedback may be of higher frequency resolution (e.g., V_{v×v×2N}_{₃}) or at a lower frequency resolution (e.g., V_{v×v×0.5N}_{₃}).

In various embodiments, based on the new DMRS based PMI feedback, the method may include configuring the UE to update the CQI and RI. In certain embodiments, the CQI and RI may be updated substantially simultaneously. The RI and the CQI may be smaller than the variants which have been transmitted at T=0: the CSI-RS based CSI feedback. Thus, the method may include encoding each of the RI and the CQI differentially with respect to reference values of RI and CQI, respectively, transmitted at T=0: the CSI-RS based CSI feedback, where the quantization levels represented lead to a final smaller value. For example, for the differential CQI,

$${CQI}_{diff} = \frac{CQI ( Δ T )}{CQI ( T = 0 )} ,$$

quantization levels may all be used in a range <1. The differential RI may be transmitted where the levels that need to be encoded are {1, . . . , RI(T=0)}.

In various embodiments, in a case of a reduced RI (for example, UE 220 updates rank to v′<v), the CSI-RS precoder update may occur at NE 230 in two ways. First, UE 220 may modify the DMRS based updated to drop the last discarded v-v′ layer(s) or NE 230 may drop the last discarded v-v′ layer(s) of the precoder; wherein equation 3 would be revised to W_{N}_{ₜ}_{×v′}^{data}(T=1, n₃)=W_{N}_{ₜ}_{×v′}^{data}(T=0, n₃)V_{v′×v′}(T=1, n₃) (4). Second, UE 220 may modify the DMRS based updated to drop the last discarded v-v′ column(s) or NE 230 may drop the last discarded v-v′ column(s) of the precoder, wherein equation 3 would be updated to W_{N}_{ₜ}_{×v′}^{data}(T=1, n₃)=W_{N}_{ₜ}_{×v′}^{data}(T=0, n₃)V_{v×v′}(T=1, n₃) (5).

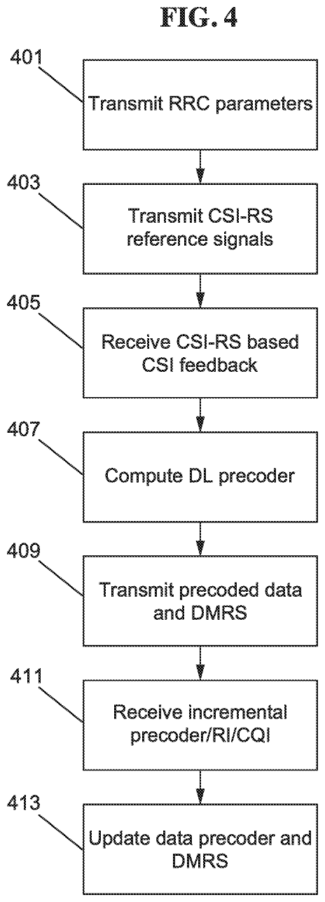

FIG. 4 illustrates an example of a flow diagram of a method that may be performed by a NE, such as NE 720 illustrated in FIG. 7, according to various example embodiments.

At 401, the method may include transmitting at least one data layer and corresponding DMRS to the UE. In some embodiments, the at least one RRC parameter may include DMRS feedback periodicity (e.g., ΔT in FIG. 1), DMRS based PMI codebook format, and CSI quantities that need to be updated (e.g., PMI, CQI, RI). At 403, the method may include transmitting reference signals CSI-RS in DL to a UE, such as UE 710 in FIG. 7. At 405, the method may include receiving CSI-RS based CSI feedback from the UE. In some embodiments, the PMI of the configured codebook structure may include any of W₁ (spatial GoB matrix), W_{f} (frequency domain basis subset matrix), W_{D} (Doppler domain basis subset matrix, and W₂ (matrix of quantized linear combination coefficients).

At 407, based upon the CSI-RS based CSI feedback, the method may include computing a DL precoder for data and/or computing DMRS W_{N}_{ₜ}_{×v×N}_{₃}^{data}(T=0), which may include weights needed to be assigned on Nₜ antenna ports to get v layers over N₃ subbands. In some embodiments, the method may include applying the computed DL precoder on DMRS in a DL domain.

At 409, the method may include the gNB transmitting precoded data and DMRS to the UE. At 411, the method may include receiving an “incremental” precoder V_{v×v×N}_{₃}, which may also be compressed in frequency and Doppler domain. Based upon H_{N}_{ᵣ}_{×v×N}_{_{f}}^{dmrs}, an optimum “incremental” precoder may be computed over an existing CSI-RS based precoder W_{N}_{ₜ}_{×v×N}_{₃} and/or updates for other CSI quantities, such as RI and CQI. The new “incremental” precoder may provide a rotation to a vector space of W_{N}_{ₜ}_{×v×N}_{₃} in order to reduce channel aging effect (i.e., rotate the vector space according to new information captured by the DMRS channel at time T=1).

At 413, the method may include updating the DMRS, transmitted rank, MCS, and/or data precoder at one subband position n₃ (or at one FD component index) as W_{N}_{ₜ}_{×v}^{data}(T=1, n₃)=W_{N}_{ₜ}_{×v}^{data}(T=0, n₃)V_{v×v}(T=1, n₃).

In various embodiments, based on the new DMRS based PMI feedback, the method may include configuring the UE to update the CQI and RI. In certain embodiments, the CQI and RI may be updated substantially simultaneously. The RI and the CQI may only be smaller than the variants which have been transmitted at T=0: the CSI-RS based CSI feedback. Thus, UE 220 may encode each of the RI and the CQI differentially with respect to reference values of RI and CQI, respectively, transmitted at T=0: the CSI-RS based CSI feedback, where the quantization levels represented lead to a final smaller value. For example, for the differential CQI

$${CQI}_{diff} = \frac{CQI ( Δ T )}{CQI ( T = 0 )} ,$$

quantization levels may all be used in a range <1. The differential RI may be transmitted where the levels that need to be encoded are {1, . . . , RI(T=0)}.

In various embodiments, in a case of a reduced RI (for example, UE 220 updates rank to v′<v), the CSI-RS precoder update may occur at NE 230 in two ways. First, UE 220 may modify the DMRS based updated to drop the last discarded v-v′ layer(s) or NE 230 may drop the last discarded v-v′ layer(s) of the precoder; wherein equation 3 would be revised to W_{N}_{ₜ}_{×v′}^{data}(T=1, n₃)=W_{N}_{ₜ}_{×v′}^{data}(T=0, n₃)V_{v′×v′}(T=1, n₃) (4). Second, UE 220 may modify the DMRS based updated to drop the last discarded v-v′ column(s) or NE 230 may drop the last discarded v-v′ column(s) of the precoder, wherein equation 3 would be updated to W_{N}_{ₜ}_{×v′}^{data}(T=1, n₃)=W_{N}_{ₜ}_{×v′}^{data}(T=0, n₃)V_{v×v′}(T=1, n₃) (5).

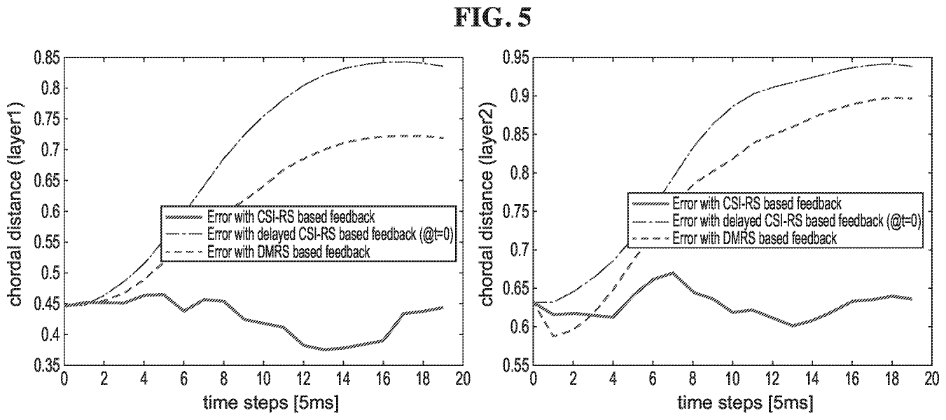

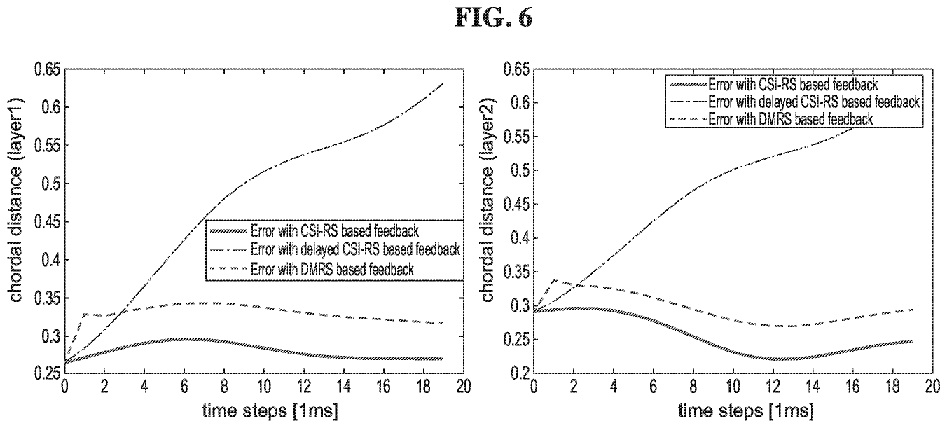

FIGS. 5 and 6 illustrate three example cases with a chordal distance measure

$$( d = \sqrt{1 - {‖ {e}_{ref}^{H} {e}_{test} ‖}^{2}} )$$

between the actual channel eigenvectors and precoder present at the base station, according to some embodiments. The lower curve represents CSI-RS based CSI feedback every 5 ms; the middle curve represents CSI-RS based CSI feedback at time T=0 and precoder weights are held constant by the gNB; and the upper curve represents CSI-RS based CSI feedback at time T=0 and precoder weights incrementally updated using DMRS based CSI feedback. The curves are based on the following settings: 3GPP DUMa channel, carrier freq=2 GHz, 20 MHz bandwidth, Nₜ=32 antenna ports, N₃=13 subbands, 2 layer transmission was assumed and the UE was assumed to have Nᵣ=2 receive antennas. According to some embodiments discussed above, a lower chordal distance error may be achieved between the actual channel eigenvectors and precoder present at the gNB, which may be higher than the first case (CSI-RS based CSI feedback every 5 ms for low speed user or 1 ms for high speed user (not feasible in practice). However, DMRS based CSI feedback may require less UL overhead compared to that case, and thus avoids excess DL resources consumption because of the CSI-RS transmission to many UEs.

FIG. 7 illustrates an example of a system according to certain example embodiments. In one example embodiment, a system may include multiple devices, such as, for example, UE 710 and/or NE 720.

UE 710 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

NE 720 may be one or more of a base station, such as an eNB or gNB, a serving gateway, a server, and/or any other access node or combination thereof. Furthermore, UE 710 and/or NE 720 may be one or more of a citizens broadband radio service device (CBSD).

NE 720 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 710 and/or NE 720 may include at least one processor, respectively indicated as 711 and 721. Processors 711 and 721 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 712 and 722. The memory may be fixed or removable. The memory may include computer program instructions or computer code contained therein. Memories 712 and 722 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 711 and 721, memories 712 and 722, and any subset thereof, may be configured to provide means corresponding to the various blocks of FIGS. 2-4. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 7, transceivers 713 and 723 may be provided, and one or more devices may also include at least one antenna, respectively illustrated as 714 and 724. The device may have many antennas, such as an array of antennas configured for multiple input multiple output (MIMO) communications, or multiple antennas for multiple RATs. Other configurations of these devices, for example, may be provided. Transceivers 713 and 723 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 2-4). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 2-4. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

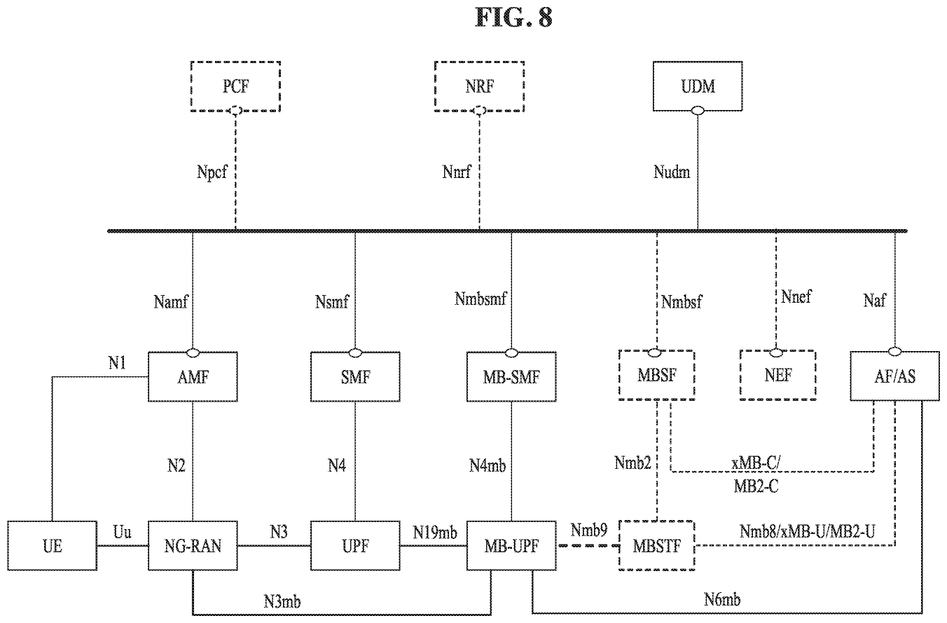

FIG. 8 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The UE and NE illustrated in FIG. 8 may be similar to UE 710 and NE 720, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processor 711 and memory 712 may be included in or may form a part of processing circuitry or control circuitry. In addition, in some example embodiments, transceiver 713 may be included in or may form a part of transceiving circuitry.

For instance, in certain example embodiments, apparatus 710 may be controlled by memory 712 and processor 711 to transmit CSI-RS based CSI feedback generated according to a configured codebook to a network entity, generate DMRS based precoding matrix indicator feedback, and transmit the DMRS based precoding matrix indicator feedback to the network entity.

In addition, in some example embodiments, apparatus 720 may be controlled by memory 722 and processor 721 to receive CSI-RS based CSI feedback generated according to a configured codebook from a UE, generate, based upon the CSI-RS based CSI feedback, a downlink precoder and compute at least one DMRS, and update the downlink precoder and at least one MCS.

In some example embodiments, an apparatus (e.g., apparatus 710 and/or apparatus 720) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for providing CSI updates based on DMRS transmissions.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
5GS Fifth Generation System
AI Artificial Intelligence
AMF Access and Mobility Management Function
ASIC Application Specific Integrated Circuit
BS Base Station
CBSD Citizens Broadband Radio Service Device
CN Core Network
CNN Convolutional Neural Network
CPU Central Processing Unit
CQI Channel Quality Indicator
CRC Cyclic Redundancy Check
CRI Channel State Information Reference Signal Resource Indicator
CSI Channel State Information
CSI-IM Channel State Information Interference Measurements
CSI-RS Channel State Information Reference Signal
DCI Downlink Control Information
DFT Discrete Fourier Transform
DL Downlink
DMRS Demodulation Reference Signal
eMBB Enhanced Mobile Broadband
eMTC Enhanced Machine Type Communication
eNB Evolved Node B
EPS Evolved Packet System
FDD Frequency Division Duplex
FePS Further Enhanced Port Selection
gNB Next Generation Node B
GoB Grid of Beam
GPS Global Positioning System
HDD Hard Disk Drive
IE Information Element
LCC Linear Combination Coefficient
LTE Long-Term Evolution
LTE-A Long-Term Evolution Advanced
MAC Medium Access Control Control Element
MBS Multicast and Broadcast Systems
MCS Modulation and Coding Scheme
MEMS Micro Electrical Mechanical System
MIMO Multiple Input Multiple Output
ML Machine Learning
MME Mobility Management Entity
mMTC Massive Machine Type Communication
MPDCCH Machine Type Communication Physical Downlink Control Channel
MTC Machine Type Communication
MU Multi-User
NAS Non-Access Stratum
NB-IoT Narrowband Internet of Things
NE Network Entity
NG Next Generation
NG-eNB Next Generation Evolved Node B
NG-RAN Next Generation Radio Access Network
NN Neural Networks
NR New Radio
NR-U New Radio Unlicensed
OFDM Orthogonal Frequency Division Multiplexing
OLLA Outer Loop Link Adaptation
PDA Personal Digital Assistance
PDCCH Physical Downlink Control Channel
PDSCH Physical Downlink Shared Channel
PDU Protocol Data Unit
PHY Physical
PMI Precoding Matrix Indicator
PRACH Physical Random Access Channel
PRB Physical Resource Block
P-RNTI Paging Radio Network Temporary Identifier
PUCCH Physical Uplink Control Channel
PUSCH Physical Uplink Shared Channel
RAM Random Access Memory
RAN Radio Access Network
RAT Radio Access Technology
RE Resource Element
RI Rank Indicator
RLC Radio Link Control
RRC Radio Resource Control
RS Reference Signal
SD Spatial Domain
SMF Session Management Function
SRB Signaling Radio Bearer
SRS Sounding Reference Signals
SSB Synchronization Signal Block
SU Single User
TDD Time Division Duplex
UCI Uplink Control Information
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network

1. A method, comprising:
transmitting, by a user equipment, channel state information reference signal based channel state information feedback generated according to a configured codebook to a network entity;
generating, by the user equipment, demodulation reference signal based precoding matrix indicator feedback according to the configured codebook to a network entity;
transmitting, by the user equipment, the demodulation reference signal based precoding matrix indicator feedback to the network entity.

2. The method of claim 1, further comprising:
generating, by the user equipment, at least one demodulation reference signal based channel quality indicator.

3. The method of claim 1, further comprising:
updating, by the user equipment, at least one of a rank indicator or channel quality indicator.

4. The method of claim 1, further comprising:
measuring, by the user equipment, an effective channel of at least one downlink demodulation reference signal channel.

5. The method of claim 1, wherein the configured codebook comprises at least one of spatial grid-of-beams matrix, frequency domain basis subset matrix, Doppler domain basis subset matrix, or a matrix of quantized linear combination coefficients.

6. The method of claim 1, wherein at least one of a rank indicator and channel quality indicator are updated differentially.

7. A method, comprising:
receiving, by a network entity, channel state information reference signal based channel state information feedback generated according to a configured codebook from a user equipment;
generating, by the network entity, based upon the channel state information reference signal based channel state information feedback, a downlink precoder and computing at least one demodulation reference signal;
updating, by the network entity, the downlink precoder and at least one modulation and coding scheme.

8. The method of claim 7, wherein the downlink precoder is updated as a function of an older downlink precoder plus a DMRS based feedback W_{N}_{ₜ}_{×v}^{data}(T=1, n₃)=W_{N}_{ₜ}_{×v}^{data}(T=0, n₃)V_{v×v}(T=1, n₃).

9. The method of claim 7, further comprising:
transmitting, by the network entity, the demodulation reference signal to the user equipment.

10. The method of claim 7, further comprising:
receiving, by the network entity, an incremental precoder generated.

11. An apparatus, comprising:
at least one processor; and
at least one memory including computer program code,
wherein the at least one memory and the computer program code are configured to, with the at least one processor, cause the apparatus at least to:
transmit channel state information reference signal based channel state information feedback generated according to a configured codebook to a network entity;
generate demodulation reference signal based precoding matrix indicator feedback according to the configured codebook to a network entity;
transmit the demodulation reference signal based precoding matrix indicator feedback to the network entity.

12. The apparatus of claim 11, wherein the at least one memory and the computer program code are further configured to, with the at least one processor, cause the apparatus at least to:
generate at least one demodulation reference signal based channel quality indicator.

13. The apparatus of claim 11, wherein the at least one memory and the computer program code are further configured to, with the at least one processor, cause the apparatus at least to:
update at least one of a rank indicator or channel quality indicator.

14. The apparatus of claim 11, wherein the at least one memory and the computer program code are further configured to, with the at least one processor, cause the apparatus at least to:
measure an effective channel of at least one downlink demodulation reference signal channel.

15. The apparatus of claim 11, wherein the configured codebook comprises at least one of spatial grid-of-beams matrix, frequency domain basis subset matrix, Doppler domain basis subset matrix, or a matrix of quantized linear combination coefficients.

16. The apparatus of claim 11, wherein at least one of a rank indicator and channel quality indicator are updated differentially.

17. An apparatus, comprising:
at least one processor; and
at least one memory including computer program code,
wherein the at least one memory and the computer program code are configured to, with the at least one processor, cause the apparatus at least to:
receive channel state information reference signal based channel state information feedback generated according to a configured codebook from a user equipment;
generate based upon the channel state information reference signal based channel state information feedback, a downlink precoder and computing at least one demodulation reference signal; and
update the downlink precoder and at least one modulation and coding scheme.

18. The apparatus of claim 17, wherein the downlink precoder is updated as a function of an older downlink precoder plus a DMRS based feedback W_{N}_{ₜ}_{×v}^{data}(T=1, n₃)=W_{N}_{ₜ}_{×v}^{data}(T=0, n₃)V_{v×v}(T=1, n₃).

19. The apparatus of claim 17, wherein the at least one memory and the computer program code are further configured to, with the at least one processor, cause the apparatus at least to:
transmit the demodulation reference signal to the user equipment.

20. The apparatus of claim 17, wherein the at least one memory and the computer program code are further configured to, with the at least one processor, cause the apparatus at least to:
receive an incremental precoder generated.

21-33. (canceled)
